(19) United States
(12) Patent Application Publication
(10) Pub. No.: US 2011/0261704 A1
(43) Pub. Date: Oct. 27, 2011

(54) MULTI-CARRIER OPERATIONAL MODES IN WIRELESS COMMUNICATIONS PROTOCOL, METHOD OF INITIALIZING A MOBILE STATION IN ORDER TO PREPARE FOR MULTI-CARRIER OPERATION IN SAME, AND CARRIER MANAGEMENT METHOD IN SAME

(76) Inventor: Kamran Etemad, Potomac, MD (US)

(21) Appl. No.: 12/766,170

(22) Filed: Apr. 23, 2010

(51) Int. Cl. H04W 24/00; H04W 72/04

(52) U.S. Cl. 370/252; 370/329

(57) ABSTRACT

Multi-carrier operational modes in a wireless communications protocol are described, along with a method of initializing a mobile station in order to prepare for multi-carrier operation and a carrier management method within a wireless communications protocol.

### PRIORITY CLAIM

This application claims the benefit of priority under 35 U.S.C. §119(e) to U.S. Provisional Patent Application Ser. No. 61/173,204, filed Apr. 28, 2009, which is incorporated herein by reference in its entirety.

### FIELD OF THE INVENTION

The disclosed embodiments of the invention relate generally to wireless communications, and relate more particularly to wireless multi-carrier operations.

### BACKGROUND OF THE INVENTION

The Media Access Control (MAC) layer in computer communications services facilitates communication between terminals or network nodes by providing addressing information and access control. Efficient MAC operation contributes to overall network efficiency and performance.

### BRIEF DESCRIPTION OF THE DRAWINGS

The disclosed embodiments will be better understood from a reading of the following detailed description, taken in conjunction with the accompanying figures in the drawings in which:

FIG. 1 is a flowchart illustrating a procedure for initialization of an MS, following network entry, to prepare for subsequent multi-carrier operation according to an embodiment of the invention;

FIG. 2 illustrates the initiation and termination of multi-carrier processing at an AMD according to an embodiment of the invention;

FIG. 3 is a flowchart illustrating a method of initializing a mobile station in order to prepare for multi-carrier operation with a base station in a wireless communications protocol according to an embodiment of the invention; and

FIG. 4 is a flowchart illustrating a carrier management method within a wireless communications protocol that utilizes a primary carrier capable of carrying user traffic and control information between a base station and a mobile station and further capable of carrying control information for a secondary carrier according to an embodiment of the invention.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements, while similar reference numerals may, but do not necessarily, denote similar elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

### DETAILED DESCRIPTION OF THE DRAWINGS

The clear definition of efficient MAC operation in multiple-carrier environments according to embodiments of the invention will contribute to greater performance in wireless communication networks. Similar performance gains may be obtained from messaging definitions directed toward the assignment and activation/deactivation of secondary carriers as well as from optimization instructions regarding mobile station (MS) power saving and multi-carrier processing according to embodiments of the invention.

Embodiments of the invention address the management of multiple carriers: how to assign them, how to activate them, and so forth. The allocation of secondary carriers is often a dynamic process: depending on such factors as channel conditions and the Quality of Service (QoS) that the user needs, more carriers may be added and then removed when they are no longer needed. Whether they are needed depends on many factors including MS capability, e.g., how many carriers can receive, how many carriers can transmit, etc.

### Multi-Carrier Types and Operational Modes

In one embodiment, the carriers involved in a multi-carrier mode of operation from an MS point of view are one of two types: primary carriers and secondary carriers. A primary carrier is a carrier used by a base station (BS) to exchange traffic and Physical Layer (PHY)/MAC control signaling (e.g., MAC management messages) with an MS. A base station may be deployed with multiple carriers but each MS in the BS has only one primary carrier (which is also used when the MS is operating in single carrier mode). Secondary carriers are additional carriers that the MS may use for traffic, but only per the BS's specific commands and rules received on the primary carrier. In multi-carrier operation a common MAC can utilize radio resources in one or more of the secondary carriers while maintaining full control of MS mobility, state, and context through the primary carrier.

In certain embodiments of the invention both primary and secondary carriers are capable of supporting both user traffic and control information but the primary carrier acts as an anchor point for the secondary carrier. Thus, in addition to modes in which secondary carriers carry user traffic only, the secondary carriers can also operate in modes where they carry some of their own in-band signaling control information such as, for example, hybrid automatic repeat request (HARM) and Channel Quality (CQI) feedback, timing advanced and power control. At the same time, more robust signaling such as for handover, paging, security, mobility, MS state management, and the like, will typically (at least in certain embodiments) be handled by the primary carrier.

As an example, in certain embodiments the secondary carrier is used to expand the bandwidth of the system in order to provide a higher data rate to the user so it includes additional traffic channels for the user as well as some in-band signaling to maintain those channels. In some cases, some of those in-band signal links—some of the feedback, for example—may also be transmitted on the secondary carrier. If data are received on the secondary carrier then feedback may not be sent on the same carrier. Instead, feedback stating that data were received on the primary carrier and on the secondary carrier may be sent on the primary carrier. In such embodiments, in other words, feedback would not be sent on both the primary and secondary carriers. Rather, the primary carrier would convey a single feedback signal indicating whether data were received on the primary carrier, on the secondary carrier, or on both.

In at least certain embodiments the primary carrier is responsible for managing the MS. For example, the primary carrier directs the MS to go to sleep, go to idle, perform a handover operation, and the like. The primary carrier can also activate additional secondary carriers, thereby expanding effective bandwidth. One can therefore have allocation and resources on multiple carriers. To state it another way, in these embodiments the secondary carriers may be dynamically turned on and off at the direction of the primary carrier; a connection with the primary carrier is always maintained.

Based on the primary and/or secondary usage and target services, the carriers of a multi-carrier system may be configured differently as follows:
Fully configured carrier: A standalone carrier for which all control channels including synchronization, broadcast, multicast, and unicast control signaling are configured. A fully configured carrier supports both single-carrier MSs and multi-carrier MSs.
Partially configured carrier: A carrier configured for downlink-only transmission in TDD or a downlink carrier without paired uplink (UL) carrier in FDD mode. Such supplementary carriers may be used only in conjunction with a primary carrier and cannot operate standalone to offer IEEE 802.16m services for an MS. Whether a carrier is fully configured or partially configured may be indicated using Advanced Preamble of the carrier. In at least one embodiment, the MS shall not attempt network entry or handover to a partially configured carrier.

A primary carrier is fully configured while a secondary carrier may be fully or partially configured depending on deployment scenarios. A secondary carrier for an MS, if fully configured, may serve as primary carrier for other MSs. Multiple MSs, each with a different primary RF carrier, may also share the same secondary carrier.

Consider an embodiment where all carriers are fully configured, i.e., where every carrier is self-contained, and are capable of carrying their own signaling. If a BS has two carriers, carrier 1 and carrier 2, a first user may use carrier 1 as its primary carrier and carrier 2 as its secondary carrier. A second user may use carrier 2 as its primary carrier and carrier 1 as its secondary carrier. If the first user needs additional bandwidth then both carrier 1 and carrier 2 may be dedicated to the first user, in which case carrier 1 is still the primary carrier and carrier 2 is a carrier from which resources have been borrowed in order to increase the data rate for the first user. Again, in this embodiment each user's primary carrier is that carrier that the user always comes back on and uses for any kind of broadcast monitoring, paging, and the like. The secondary carrier is only used when the user is in connected mode in traffic state to exchange additional traffic beyond what the MS does with the primary carrier.

The following multi-carrier operation modes are identified, which may all or independently be supported:
Multi-Carrier Aggregation: A multi-carrier mode in which the MS maintains its physical layer connection and monitors the control signaling on the primary carrier while processing data on the secondary carrier. The resource allocation to an MS may span across a primary and multiple secondary RF carriers. Link adaptation feedback mechanisms should incorporate measurements relevant to both primary and secondary carriers. In this mode the system may assign secondary carriers to an MS in the downlink and/or uplink asymmetrically based on system load (i.e., for static/dynamic load balancing), peak data rate, or QoS demand. Aggregation refers to the receipt of a primary carrier and then of a secondary carrier at the same time (without disrupting reception of the primary carrier). This mode may require the MS to have multiple receivers. This is referred to as aggregation because traffic is physically aggregated across multiple carriers. If each carrier has a bandwidth of 20 MHz, for example, the effective bandwidth after aggregation would be about 40 MHz.
Multi-Carrier Switching: A multi-carrier mode in which the MS switches its physical layer connection from the primary to the secondary carrier per BS instruction. The MS connects with the secondary carrier for a specified time period (a time period that is known to the BS) and then returns to the primary carrier. When the MS is connected to the secondary carrier, the MS is not required to maintain its physical layer connection to the primary carrier. This mode may be used in broadcast/multicast or other unicast services for switching to partially-configured carriers for downlink transmission-only service. As an example, if a large file is to be sent but there is a desire to avoid having that traffic restrict bandwidth on the current carrier a switch to a different carrier may be made and instructions provided to complete the download and then return to the primary carrier in (say) 10 milliseconds. The BS knows that the other carrier is being used for those 10 milliseconds, and the MS knows what to do during those 10 milliseconds.
Primary Carrier Change: A multi-carrier mode in which the BS changes the primary carrier of an MS. This mode is similar to a fast inter-carrier handover where only the PHY changes while maintaining MS control on the same MAC. This mode of multi-carrier is required by all MSs. The Primary Carrier Change mode may involve the primary carrier being changed from carrier 1 to carrier 2 without doing a full network-level handover. In that case the change is local to the base station rather than being handled at the network level because the change is simply a change from one radio frequency to another. Full control goes from one carrier to another carrier. From an upper-layer perspective the change was a disconnection. From a lower-level perspective the change was along the lines of a change from a 10 MHz channel to a 20 MHz channel or from a 20 MHz channel to another 20 MHz channel.

The following are common to all multi-carrier modes of operation:
The system defines N standalone fully-configured RF carriers; each fully configured with all synchronization, broadcast, multicast and unicast control signaling channels. Each MS in the cell is connected to and its state being controlled through only one of the fully-configured carriers designated as its primary carrier.
The system may also define M (M≧0) partially-configured RF carriers, which can only be used as secondary carriers along with a primary carrier, for downlink only data transmissions.
The set of all supported radio carriers in a BS is called Available Carriers.
The multiple carriers may be in different parts of the same spectrum block or in non-contiguous spectrum blocks. Support of non-contiguous spectrum blocks may require additional control information on the secondary carriers.
In addition to information about the (serving) primary carrier, a BS, supporting any multi-carrier mode, also provides MSs with some basic information about other available carriers through such primary carrier. The basic multi-carrier configuration informs MSs of the presence, bandwidth, duplexing, and location in the spectrum for all available carriers to help MS prepare for any multi-carrier operation. The primary carrier may also provide an MS the extended information about the configuration of the secondary carrier.

### MAC Operation

The MAC operation for multi-carrier is the same as for single-carrier mode, and messaging is carried on the primary carrier for each MS unless specified otherwise in the following.

### Network Entry

The network entry in multi-carrier mode is the same as single-carrier mode where the MS and BS also indicate their support for multi-carrier modes during the capability negotiation. An MS can only perform network entry (or network re-entry) procedures with a fully-configured carrier. Once the MS detects the A-PREAMBLE on a fully-configured carrier, the MS may proceed with reading Super Frame Header (SFH) or extended system parameters and system configuration information.

During the initial network entry, the MS will inform the BS of its support of multi-carrier transmission by REG-REQ message and the BS will indicate if it supports any multi-carrier modes for that MS through REG-RSP message. The basic multi-carrier capability exchange uses a two bit code in REG-REQ/RSP message with the following indications:

| b1, b2 | Multi-carrier Capabilities |
|---|---|
| 00 | No MC modes |
| 01 | Multi-carrier Aggregation |
| 10 | Multi-carrier Switching |
| 11 | Both Multi-carrier Aggregation and Switching |

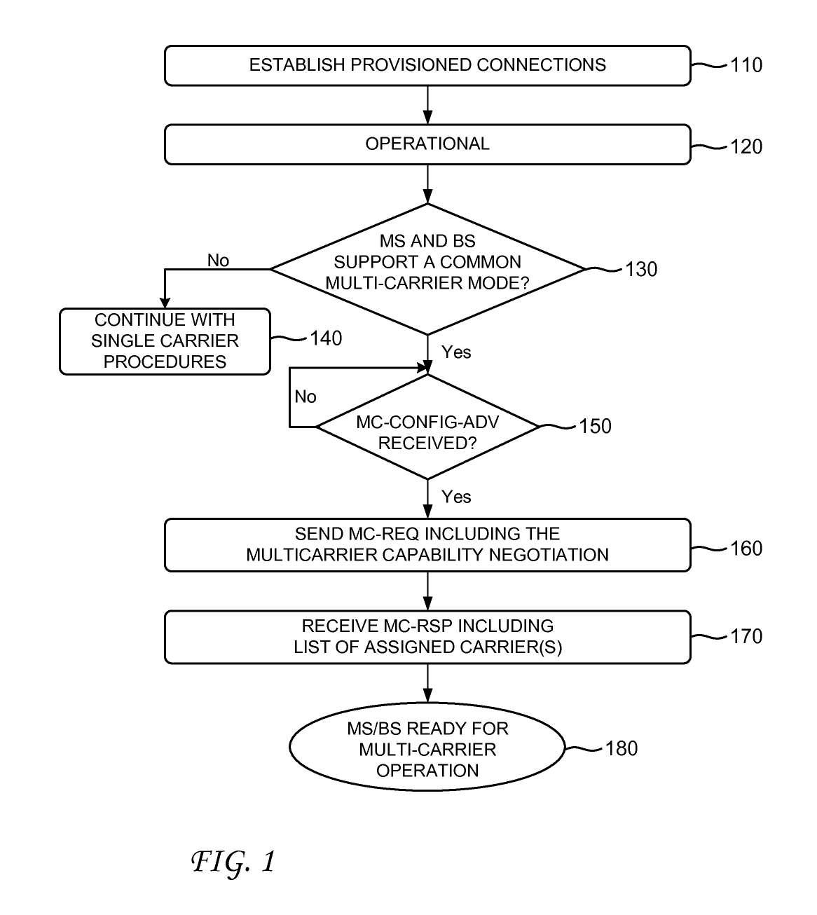

The procedure according to an embodiment of the invention for initialization of an MS, following network entry, to prepare for subsequent multi-carrier operation according to an embodiment of the invention is shown in FIG. 1. This procedure includes:
Obtaining the multi-carrier configuration for available carriers at the BS
Obtaining information about Assigned Carriers consisting of two steps:
   1. Provide BS with information on MS's supportable carriers and their combined multi-carrier configurations.
   2. Obtain information about the subset of available carrier, hereby referred to as the Assigned Carriers, which BS may utilize in subsequent multi-carrier operation for that MS.

The MS does not perform any MAC or PHY processing on an assigned carrier until such carrier is activated per BS's direction. The network entry process (which is the same as for Single Carrier Mode) includes basic multi-carrier capability negotiation during REG-REQ-RSP. Referring still to FIG. 1, a block 110 refers to the establishment of provisioned connections. A block 120 establishes that such connections are operational.

In block 130 the query whether the MS and the BS support a common multi-carrier mode is raised. If the answer is no, processing continues according to single carrier procedures (140). If the answer is yes, and the MC-CONFIG-ADV message has been received (150), MC-REQ, including multi-carrier capability negotiation, is sent (160). If the answer is yes but MC-CONFIG-ADV has not been received then processing returns to a point just prior to the MC-CONFIG-ADV receipt query.

Following transmission of MC-REQ, MC-RSP is received, including a list of assigned carriers (170). The MS and the BS are then ready for multi-carrier operation (180).

### MSs Obtaining MC Configuration for Available Carriers

While the information about radio configuration for a serving carrier is broadcast on SFH, the BS shall, in at least one embodiment, provide MSs with basic radio configuration for other available carriers in the BS through MC-ADV message. This message is periodically broadcast by BS, which includes the multi-carrier mode and the configurations supported by the BS. The multi-carrier configuration information is relevant to and may be used by all MSs in any multi-carrier mode or in single-carrier mode. In cases where the information about available carriers is the same across the network, the network can provide the MS with such information upon initial network entry as part of provisioning, and the MS can store and apply this information until an update is provided by the network.

MC_CONG_ADV (Multi-Carrier Configuration Advertisement) Message: The BS shall, in at least one embodiment, periodically broadcast MC-ADV message for reception by all MSs. This message includes information such as center frequency, duplexing mode, bandwidth, and other parameters if different than the serving carrier and it also assigns each carrier a physical carrier index, which is used by the BS and the MS for any reference to any available carrier. The configuration information is applicable to all MSs.

The following parameters may be included in the MC-ADV message for each available carrier:
Physical Carrier Index
Center Frequency (e.g. Band Class Index and channel index)
Channel Bandwidth
Carrier Type (legacy only mode, fully/partially configured)
Duplexing Mode
Primary Preamble Index
Secondary Preamble Index
Transmit Power

Information that is the same as for the serving carrier may be omitted to reduce overhead.

### Obtaining Information about Assigned Carriers

Following capability negotiation, and if the BS confirms availability of multi-carrier features for an MS, the MS may request the BS, through an MC-REQ (Multi-Carrier Request) Message, to obtain information about Assigned Carriers. Assigned Carriers are the subset of available carriers that may potentially be used by the BS for any subsequent multi-carrier operation for such MS. The BS responds to the MS's request through MC-RSP (Multi-Carrier Response) Message.

MC-REQ (Multi-Carrier Request) Message: The Multi-Carrier Request Message is sent by the MS to the BS to request the list of Assigned Carriers. This message shall, in at least one embodiment, include all information about the MS's supported multi-carrier configurations that are needed by the BS to decide which carriers or their combinations to assign to the MS and activate when needed.

The following are the parameters that shall be included in the MC-REQ message in at least one embodiment of the invention:
MS multi-carrier capabilities and limitations
Maximum carriers in DL/UL
Maximum separation between carriers
List of candidate assigned carrier
Support of data transmission over guard sub-carrier

MC-RSP (Multi-Carrier Response) Message: Based on information provided by the MS on MC-REQ, the BS shall, in at least one embodiment, respond to the MS through the MC-RSP message to provide the MS with information about its assigned carriers. In at least one embodiment, the following are the parameters that shall be included in MC-RSP message:
List of assigned carriers
Additional/Detailed MC configuration for assigned carrier (optional)
Support of data transmission over guard sub-carrier

MC-RSP is typically sent to the MS by the BS in response to the MC-REQ message, but it may also be sent to an MS in order to update the list of assigned carriers. The order of appearance of a carrier in the MC-RSP message can be used as a logical carrier index for subsequent references to assigned carriers. Alternatively the physical carrier index provided in the MC_CONF_ADV message may be used for such addressing.

### Bandwidth Request and Resource Allocation

All bandwidth requests are transmitted on the MS's primary carrier using the assigned bandwidth request channel following the same procedures as defined for single-carrier mode. Bandwidth requests using piggyback may be transmitted in MPDUs over the secondary carrier(s) as well as the primary carrier consistent with single-carrier mode.

When a bandwidth request is received, the BS may allocate downlink or uplink resources which belong to a specific carrier or a combination of multiple carriers. The multi-carrier resource assignment for carrier aggregation can use the same AMAP-IEs as single carrier mode, where A-MAP messages for each active carrier are transmitted in the respective carrier.

Alternatively, a special Multicarrier AMAP-IE may be used and transmitted on the primary carrier to allocate resources across primary and secondary carriers in the same composite information element.

The service setup/change messages (i.e., DSx messages) are typically transmitted only through the MS's primary carrier. The service flow is defined for a common MAC entity and MS's QoS context represented by an SFID is applicable across the primary carrier and secondary carrier(s) and collectively applied to all carriers of the MS.

### DL CINR Report Operation

A BS may assign CQI channels to each carrier of an MS. When CQI channel is assigned, the MS reports CINR for a carrier over the assigned CQI channel of the corresponding carrier. When REP-REQ/RSP messages are used for DL CINR report operation, the messages are transmitted on the MS's primary carrier. The REP-RSP message may contain CINR reports for all carriers or for each carrier of the MS.

The MS may be directed not to send CINR measurement for secondary carriers if their signal quality is lower than a threshold, in which case the BS would refrain from sending data on such secondary carrier until signal quality is improved above the thresholds and the MS restarts sending CINR measurements on that secondary carrier.

### Handover Process

An MS follows the handover process defined for single-carrier mode. All MAC management messages in relation with handover (HO) are, in at least one embodiment, transmitted over the primary carrier.

During HO preparation phase, when a BS receives an HO-REQ message from an MS or when the BS sends an HO-CMD message to the MS, the BS may exchange the information of multiple carrier capability with possible target BSs. The information includes the MS's available number of carriers, carrier aggregation or carrier switching capability.

When the information regarding MS identity (e.g., a station identifier (STID)) or security context at a target BS is pre-updated during HO preparation, the multi-carrier related information (e.g., secondary carrier) may be provided to the MS using an HO-CMD message.

After handover to a target BS is determined, an MS conducts its network re-entry with a selected carrier which becomes the MS's primary carrier at the target BS. If a secondary carrier is not provided to the MS in advance, the target BS may allocate the secondary carrier during network re-entry or the connection may change to single-carrier mode.

### Sleep Mode

When an MS enters sleep mode, the MS negotiates its sleep mode parameters (i.e., sleep window and listening window configuration) with a BS. The negotiated parameters of sleep mode are applied to an MS and all carriers power down according to the negotiated sleep mode parameters.

### Idle Mode

The MS determines a default carrier to monitor for paging and other broadcast control messages similar to single-carrier mode. Such selected carrier is the MS's primary carrier in idle mode unless changed by the BS.

Messages and procedures to initiate the idle mode are processed with MS's primary carrier. During paging listening interval, the MS monitors paging message on its primary carrier consistent with single-carrier mode. When paged, the MS performs network re-entry procedure with the primary carrier.

### Secondary Carrier Management

The process of carrier management involves exchange of an MCM-DIR/MCM-CONFIRM message between BS and MS to start, stop or make changes in multi-carrier operation modes and carriers involved. These messages enable secondary carrier activation and deactivation in multi-carrier aggregation, primary carrier change or primary to secondary switching.

Secondary-carrier management refers to activation and deactivation of carriers, which results in starting and stopping of multi-carrier processing at the MS. The activation or deactivation of secondary carrier(s) is decided by the BS based on QoS requirements, load condition of carriers and other factors and it is indicated to the MS through the MCM-DIR MAC management message.

### Secondary Carrier Activation for Aggregation

Activation of secondary carriers in aggregation mode is through MCM-DIR/MCM-CONFIRM exchange between MS and BS. The BS sends the MCM-DIR MAC management message on the primary carrier and includes the following information:
Carrier Index List (logical carrier index) and for each carrier
Action Type: (Activation or Deactivation)
Multi-carrier Operation: (Aggregation, Switching)
Optional field for feedback channel allocation on the primary carrier for MS to send channel feedback about the activated secondary carrier if such carrier is not fully configured
Combined Feedback on Primary Carrier (On/Off)
Scope: STID or flow identifier (FID). If STID MC mode may apply to any of services/connections for that MS.

In response to the MCM-DIR MAC management message, MS transmits an MCM-CONFIRM MAC management message through the primary carrier. This message confirms with the BS that the MS has successfully activated/deactivated the carriers listed in the MCM-DIRECT message.

Confirmation is sent by the MS when the MS is ready to receive allocation messages on the activated carriers. After the BS receives the MCM-IND MAC management message the BS may start transmitting allocation messages and data on such active secondary carrier(s) similar to single carrier mode.

The BS may allocate a fast feedback channel for each newly-activated secondary carrier on the MC-IND message. MS may report CQI for all downlink active secondary carriers. MS may perform periodic ranging for the uplink active secondary carriers. The sounding channel may be also transmitted by the MS when directed by the BS for uplink active secondary carriers. The MS may update the system information of all active secondary carriers and may monitor resource allocation messages for all active secondary carrier(s).

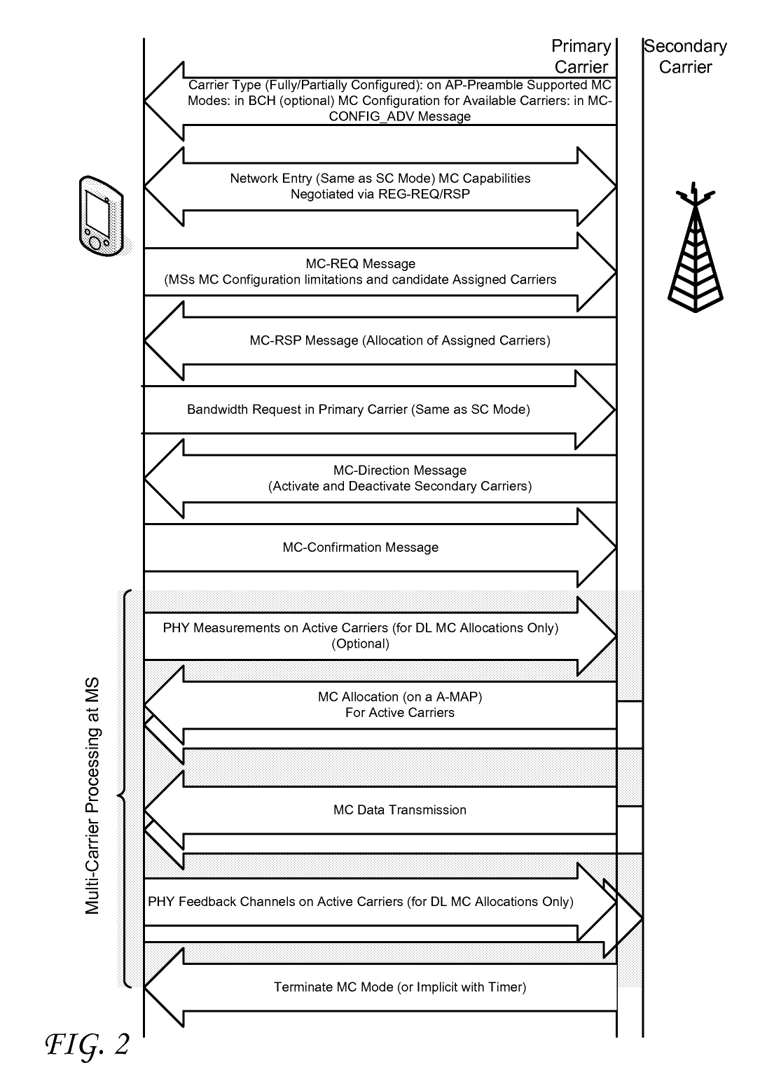

FIG. 2 illustrates the initiation and termination of multi-carrier processing at the MS according to an embodiment of the invention and in connection with the foregoing description.

### Primary Carrier Change

The BS may instruct the MS, through control signaling on the current primary carrier, to change its primary carrier to one of the available fully configured carriers within the same BS for load balancing purposes, carriers' varying channel quality, or other reasons. The MS switches to the target fully-configured carrier at an action time specified by the BS. The carrier change may also be requested by the MS through control signaling on the current primary carrier. Given that a common MAC manages both serving and target primary carriers, network re-entry procedures at the target primary carrier is not required. The BS may provide the system information of the target primary carrier that is different from the serving primary carrier via the serving primary carrier. The BS may allocate a new STID when the current STID is already served by another MS. The logical carrier indices may be re-arranged. BS may direct an MS to change the primary carrier without scanning.

The BS may instruct the MS to perform scanning on other carriers which are not serving the MS. The MS reports the scanning results back to the serving BS, which results may be used by the BS to determine the carrier for the MS to switch to. In this case, if the target carrier is not currently serving the MS, the MS may perform synchronization with the target carrier if required.

### Carrier Switching Mode

Primary to secondary carrier switching in multi-carrier mode is supported when a secondary carrier is partially configured. The carrier switching between a primary carrier and a secondary carrier can be periodic or event-triggered with timing parameters defined by a multi-carrier switching message on the primary carrier. When an MS switches to a secondary carrier, its primary carrier may provide basic information such as timing and frequency adjustment to help with MSs with fast synchronization with the secondary carrier.

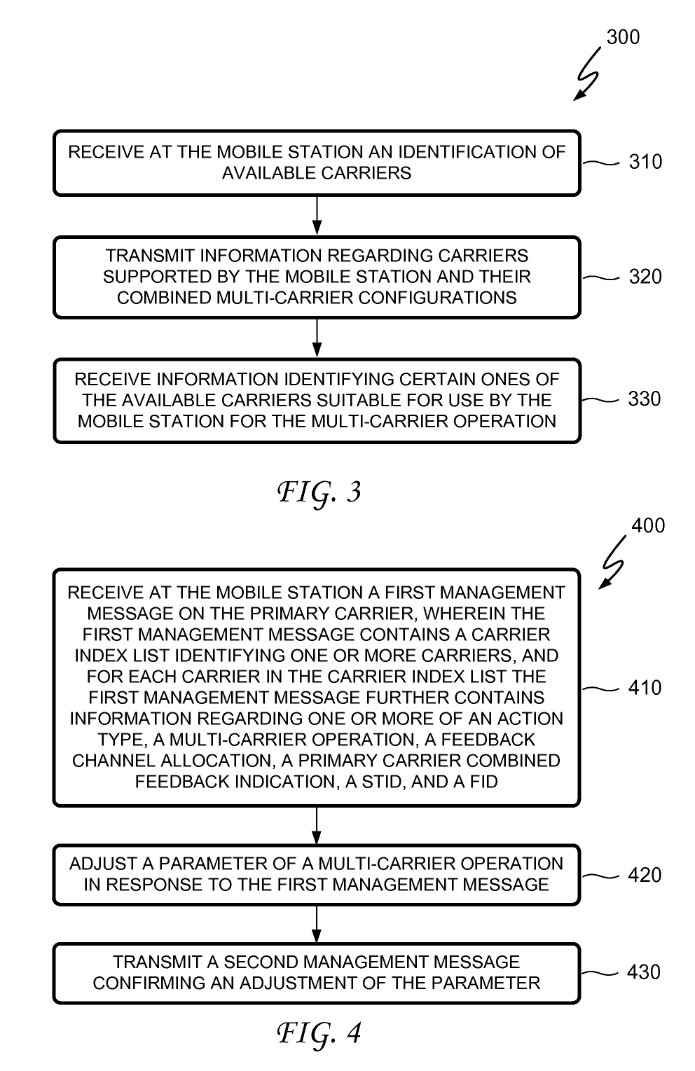

FIG. 3 is a flowchart illustrating a method 300 of initializing a mobile station in order to prepare for multi-carrier operation with a base station in a wireless communications protocol according to an embodiment of the invention.

A step 310 of method 300 is to receive at the mobile station an identification of available carriers.

A step 320 of method 300 is to transmit information regarding carriers supported by the mobile station and their combined multi-carrier configurations.

A step 330 of method 300 is to receive information identifying certain ones of the available carriers suitable for use by the mobile station for the multi-carrier operation.

FIG. 4 is a flowchart illustrating a carrier management method 400 within a wireless communications protocol that utilizes a primary carrier capable of carrying user traffic and control information between a base station and a mobile station and further capable of carrying control information for a secondary carrier according to an embodiment of the invention.

A step 410 of method 400 is to receive at the mobile station a first management message on the primary carrier, wherein the first management message contains a carrier index list identifying one or more carriers, and for each carrier in the carrier index list the first management message further contains information regarding one or more of an action type, a multi-carrier operation, a feedback channel allocation, a primary carrier combined feedback indication, a STID, and a FID.

A step 420 of method 400 is to adjust a parameter of a multi-carrier operation in response to the first management message.

A step 430 of method 400 is to transmit a second management message confirming an adjustment of the parameter.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the multi-carrier operation modes and the related structures and methods discussed herein may be implemented in a variety of embodiments, and that the foregoing discussion of certain of these embodiments does not necessarily represent a complete description of all possible embodiments.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A multi-carrier operational mode in a wireless communications protocol that utilizes a primary carrier capable of carrying user traffic and control information between a base station and a mobile station and further capable of carrying control information for a secondary carrier, the multi-carrier operational mode comprising:
a first operation in which the mobile station maintains a physical layer connection for user traffic and monitors control information on the primary carrier; and
a second operation in which the mobile station processes user traffic on the secondary carrier.

2. The multi-carrier operational mode of claim 1 wherein:
the second operation comprises processing user traffic type on multiple secondary carriers.

3. The multi-carrier operational mode of claim 1 further comprising:
a link adaptation feedback mechanism incorporating measurements relevant to both the primary carrier and the secondary carriers.

4. The multi-carrier operational mode of claim 1 wherein:
the wireless communications protocol assigns one or more secondary carriers to the mobile station according to one or more of system load, peak data rate, and quality of service demand.

5. The multi-carrier operational mode of claim 4 wherein:
the assignment of secondary carriers to the mobile station takes place in one or both of a downlink and an uplink; and
the secondary carriers are assigned asymmetrically.

6. A multi-carrier operational mode in a wireless communications protocol that utilizes a primary carrier capable of carrying user traffic and control information between a base station and a mobile station and further capable of carrying control information for a secondary carrier, the multi-carrier operational mode comprising:
a first operation in which the mobile station receives a switching instruction from the base station on the primary carrier;
a second operation in which the mobile station switches its physical layer connection from the primary carrier to the secondary carrier according to the switching instruction received from the base station; and
a third operation in which the mobile station switches its physical layer connection from the secondary carrier back to the primary carrier.

7. The multi-carrier operational mode of claim 6 wherein:
the third operation is performed after a time period that is specified in the switching instruction.

8. The multi-carrier operational mode of claim 6 wherein:
the secondary carrier is a partially-configured carrier.

9. A multi-carrier operational mode in a wireless communications protocol that utilizes a serving primary carrier capable of carrying user traffic and control information between a base station and a mobile station and further capable of carrying control information for a secondary carrier, the multi-carrier operational mode comprising:
a first operation in which the mobile station receives a primary carrier change instruction from the base station on the serving primary carrier;
a second operation in which the mobile station terminates its association with the serving primary carrier and initiates an association with a target primary carrier that is different from the serving primary carrier.

10. The multi-carrier operational mode of claim 9 further comprising:
a third operation in which the physical layer connection is changed while mobile station control on a media access control layer is maintained.

11. A method of initializing a mobile station in order to prepare for multi-carrier operation with a base station in a wireless communications protocol, the method comprising:
receiving at the mobile station an identification of available carriers;
transmitting information regarding carriers supported by the mobile station and their combined multi-carrier configurations;
receiving information identifying certain ones of the available carriers suitable for use by the mobile station for the multi-carrier operation.

12. The method of claim 11 wherein:
receiving the identification of available carriers comprises receiving a multi-carrier configuration advisement message; and
the multi-carrier configuration advisement message contains information regarding one or more of a physical carrier index, a center frequency, a channel bandwidth, a carrier type, a duplexing mode, a primary preamble index, a secondary preamble index, and a transmit power.

13. The method of claim 11 wherein:
transmitting information regarding carriers supported by the mobile station and their combined multi-carrier configurations comprises transmitting a multi-carrier request message; and
the multi-carrier request message contains information regarding one or more of mobile station multi-carrier capabilities and limitations, a maximum number of carriers in downlink/uplink, a maximum separation between carriers, a list of candidate assigned carriers, and support of data transmission over guard sub-carrier.

14. The method of claim 11 wherein:
receiving information identifying certain ones of the available carriers suitable for use by the mobile station for the multi-carrier operation comprises receiving a multi-carrier response message; and
the multi-carrier response message contains information regarding one or more of a list of assigned carriers and support of data transmission over guard sub-carrier.

15. The method of claim 14 wherein:
the multi-carrier response message further contains information regarding multi-carrier configuration for an assigned carrier.

16. A carrier management method within a wireless communications protocol that utilizes a primary carrier capable of carrying user traffic and control information between a base station and a mobile station and further capable of carrying control information for a secondary carrier, the method comprising:
receiving at the mobile station a first management message on the primary carrier;
adjusting a parameter of a multi-carrier operation in response to the first management message; and
transmitting a second management message confirming an adjustment of the parameter,
wherein:
the first management message contains a carrier index list identifying one or more carriers; and
for each carrier in the carrier index list the first management message further contains information regarding one or more of an action type, a multi-carrier operation, a feedback channel allocation, a primary carrier combined feedback indication, a STID, and a FID.

17. The method of claim 16 wherein:
the parameter of the multi-carrier operation is one or more of start multi-carrier operation, stop multi-carrier operation, change multi-carrier operation mode, and change carriers.

18. The method of claim 17 wherein:
adjusting the start multi-carrier operation parameter activates a new secondary carrier; and
the method further comprises recognizing a fast feedback channel for the new secondary carrier.

19. The method of claim 18 wherein:
the new secondary carrier is an uplink active secondary carrier; and
the method further comprises an operation in which the mobile station performs a ranging activity for the uplink active secondary carrier.

20. The method of claim 18 wherein:
the new secondary carrier is a downlink active secondary carrier; and
the method further comprises an operation in which the mobile station reports a channel quality indicator for the downlink active secondary carrier.
